(19) United States
(12) Patent Application Publication
(10) Pub. No.: US 2025/0356620 A1
(43) Pub. Date: Nov. 20, 2025

(54) IMAGE CLASSIFICATION AND OUTLIER DETECTION USING MULTI-LAYER LOSSES

(71) Applicant: Applied Materials, Inc., Santa Clara, CA (US)

(72) Inventors: Shantanu Sudhir Darveshi, Bangalore (IN); Adrienne Melissa Martin Bergh, Los Gatos, CA (US); Abhinav Kumar, Milpitas, CA (US)

(21) Appl. No.: 18/663,821

(22) Filed: May 14, 2024

(51) Int. Cl. G06V 10/764; G06V 10/762

(52) U.S. Cl. CPC G06V 10/764; G06V 10/762

(57) ABSTRACT

A method includes identifying substrate images that have been sorted into classes. The method further includes training a machine learning model using data input including the substrate images and target output including the classes. The method further includes refining the trained machine learning model using a triplet loss function based on one or more substrate images misclassified by the trained machine learning model to provide a refined trained machine learning model associated with performance of an action associated with substrate processing.

### TECHNICAL FIELD

The present disclosure relates to image classification and outlier detection, and in particular to image classification and outlier detection using multi-layer losses.

### BACKGROUND

Products are produced by performing one or more manufacturing processes using manufacturing systems. For example, substrate processing systems are used to process substrates.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes: identifying a plurality of substrate images that have been sorted into a plurality of classes; training a machine learning model using data input comprising the plurality of substrate images and target output comprising the plurality of classes; and refining the trained machine learning model using a triplet loss function based on one or more substrate images misclassified by the trained machine learning model to provide a refined trained machine learning model associated with performance of an action associated with substrate processing.

In another aspect of the disclosure, a method includes: identifying current substrate images associated with substrate processing; providing the current substrate images as input to a refined trained machine learning model, the refined trained machine learning model having been trained based on a plurality of substrate images that have been sorted into a plurality of classes and having been refined using a triplet loss function based on one or more substrate images misclassified by the trained machine learning model; obtaining, from the refined trained machine learning model, output associated with predictive data; and causing, based on the predictive data, performance of an action associated with the substrate processing.

In another aspect of the disclosure, a non-transitory machine-readable storage medium storing instructions which, when executed cause a processing device to perform operations including: identifying a plurality of substrate images that have been sorted into a plurality of classes; training a machine learning model using data input comprising the plurality of substrate images and target output comprising the plurality of classes; and refining the trained machine learning model using a triplet loss function based on one or more substrate images misclassified by the trained machine learning model to provide a refined trained machine learning model associated with performance of an action associated with substrate processing.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIG. 2 is a flow diagram of a method associated with image classification and outlier detection, according to certain embodiments.

FIGS. 3A-C are flow diagrams of methods associated with image classification and outlier detection, according to certain embodiments.

FIG. 4 is a block diagram illustrating a computer system, according to certain embodiments.

### DETAILED DESCRIPTION

Embodiments described herein are related to image classification and outlier detection using multi-layer losses (e.g., neural network image classification and outlier detection).

In substrate processing and other electronics processing, products are produced and then metrology is performed to determine if the products meet threshold values. For example, a substrate may be produced and then metrology may be performed to determine if thickness values of the substrate meet threshold film thickness values. To perform metrology, images of substrates may be captured and then different algorithms may be used with images of substrates to determine if substrates meet threshold values (e.g., determine if a substrate is good or bad).

Conventionally, a user is to choose the algorithm (e.g., from a drop-down menu) to evaluate substrate images to determine whether a substrate is good or bad. If an incorrect algorithm is used, then the metrology results are erroneous. This causes good substrates to be discarded, bad substrates to be used, manufacturing parameters to be incorrectly set, decrease in yield, and waste of material. To solve these problems, increased processor overhead, energy consumption, and bandwidth may be used.

The systems, devices, and methods of the present disclosure provide solutions to these and other problems of conventional systems.

A processing device identifies substrate images that have been sorted into classes. For example, there could be 10-15 substrate images in class and 2-3 images per cluster (e.g., sub-class) in each class (e.g., about 5 clusters per class). Each cluster may include about 2-3 substrate images. Each class may have up to about 10-15 substrate images (e.g., including 2-3 substrate images in each cluster of about 5 clusters). For classes and/or clusters that had more substrate images, a sampling may be performed to reduce the substrate images per class and/or cluster.

The processing device trains a machine learning model using data input including the substrate images and target output including the classes (e.g., about 2-3 substrate images per cluster and about 5 clusters per class) to generate a trained machine learning model.

The processing device may identify misclassified substrate images that the trained machine learning model incorrectly predicted is part of an incorrect class. The processing device may refine the trained machine learning model using a triplet loss function based on one or more misclassified substrate images to provide a refined trained machine learning model. Using the triplet loss for a substrate image that was misclassified as being in a first class (incorrect) instead of a second class (correct) may include identifying the misclassified substrate image as an anchor item, identifying a substrate image from the second class as a similar item, and identifying a substrate image from the first class as a dissimilar item.

A processing device may identify substrate images associated with substrate processing and provide the substrate images as input to the refined trained machine learning model. The processing device may obtain, from the refined trained machine learning model, output associated with predictive data. The processing device may cause, based on the predictive data, performance of an action (e.g., corrective action) associated with the substrate processing. In some embodiments, the performance of the action includes selecting an algorithm for generating of metrology data based on the substrate images.

The systems, devices, and methods of the present disclosure have advantages over conventional solutions. The present disclosure may be used to more correctly perform operations (e.g., more correctly select an algorithm for metrology) than conventional solutions. This allows the present disclosure to discard a lower amount of good substrates, use a lower amount of bad substrates, more correctly set manufacturing parameters, increase yield, and decrease waste of material compared to conventional solutions. This also allows the present disclosure to have decreased processor overhead, decreased energy consumption, and decreased bandwidth compared to conventional solutions.

Although some embodiments of the present disclosure are described with selecting an algorithm for performing metrology, in some embodiments, the present disclosure may be used to more correctly perform other substrate processing and/or substrate metrology operations.

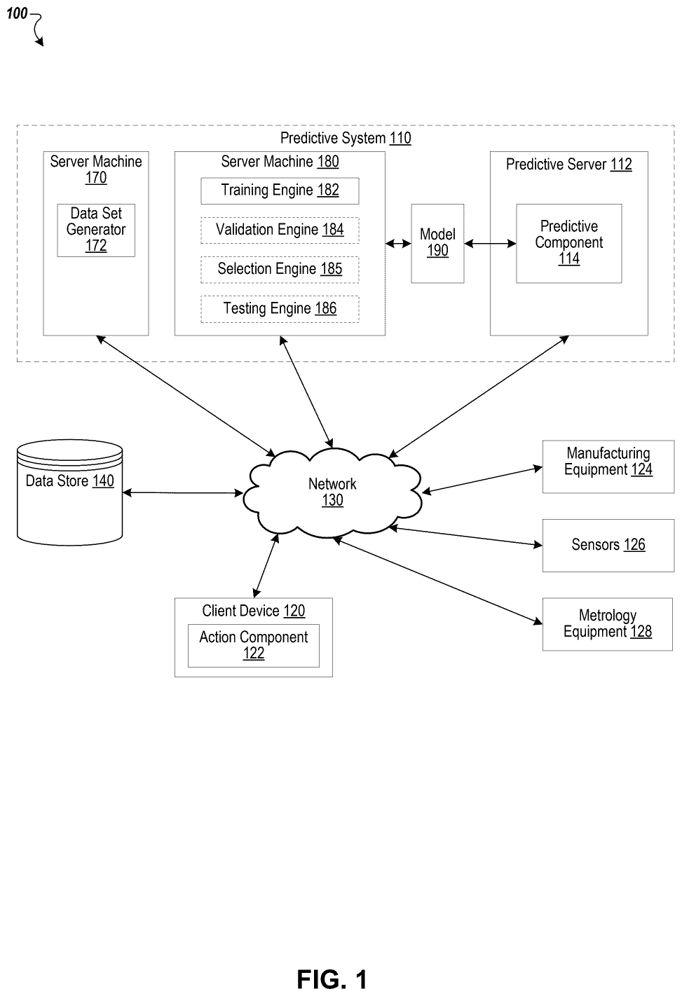

FIG. 1 is a block diagram illustrating an exemplary system 100 (exemplary system architecture), according to certain embodiments. The system 100 includes a client device 120, manufacturing equipment 124, sensors 126, metrology equipment 128, a predictive server 112, and a data store 140. In some embodiments, the predictive server 112 is part of a predictive system 110. In some embodiments, the predictive system 110 further includes server machines 170 and 180.

In some embodiments, one or more of the client device 120, manufacturing equipment 124, sensors 126, metrology equipment 128, predictive server 112, data store 140, server machine 170, and/or server machine 180 are coupled to each other via a network 130 for generating predictive data to perform an action associated with substrate processing (e.g., select an algorithm for performing metrology). In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes an action component 122. In some embodiments, the action component 122 may also be included in the predictive system 110 (e.g., machine learning processing system). In some embodiments, the action component 122 is alternatively included in the predictive system 110 (e.g., instead of being included in client device 120). Client device 120 includes an operating system that allows users to one or more of consolidate, generate, view, or edit data, provide directives to the predictive system 110 (e.g., machine learning processing system), etc.

In some embodiments, action component 122 receives user input (e.g., via a Graphical User Interface (GUI) displayed via the client device 120) and/or data (e.g., from data store 140). In some embodiments, the action component 122 transmits at least a portion of the data (e.g., user input and/or data from data store 140) to the predictive system 110, receives predictive data from the predictive system 110, and causes performance of an action associated with substrate processing (e.g., select an algorithm for performing metrology) based on the predictive data. In some embodiments, the action component 122 stores data in the data store 140 and the predictive server 112 retrieves data from the data store 140. In some embodiments, the predictive server 112 stores output (e.g., predictive data) of the trained machine learning model 190 in the data store 140 and the client device 120 retrieves the output from the data store 140. In some embodiments, the action component 122 receives an indication of an action (e.g., based on predictive data) from the predictive system 110 and causes performance of an action associated with substrate processing (e.g., select an algorithm for performing metrology) based on the indication of the action.

In some embodiments, the predictive data is associated with a predicted action associated with substrate processing (e.g., selection of an algorithm for performing metrology). In some embodiments, predictive data is associated with substrate image classification and outlier detection. In some embodiments, substrate image classification and outlier detection are performed based on the predictive data.

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 receives data (e.g., received from the client device 120, retrieved from the data store 140) and generates predictive data associated with performance of an action associated with substrate processing (e.g., select an algorithm for performing metrology). In some embodiments, the predictive component 114 uses one or more trained machine learning models 190 to determine the predictive data associated with performance of an action associated with substrate processing (e.g., select an algorithm for performing metrology). In some embodiments, trained machine learning model 190 is trained using historical data (e.g., historical substrate images and historical classes).

In some embodiments, the predictive system 110 (e.g., predictive server 112, predictive component 114) generates predictive data using supervised machine learning (e.g., supervised data set, historical data labeled with historical data, etc.). In some embodiments, the predictive system 110 generates predictive data using semi-supervised learning (e.g., semi-supervised data set, historical data is a predictive percentage, etc.). In some embodiments, the predictive system 110 generates predictive data using unsupervised machine learning (e.g., unsupervised data set, clustering, clustering based on historical data, etc.).

In some embodiments, the manufacturing equipment 124 (e.g., cluster tool) is part of a substrate processing system (e.g., integrated processing system). The manufacturing equipment 124 includes one or more of a controller, an enclosure system (e.g., substrate carrier, front opening unified pod (FOUP), auto teach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers (e.g., multi-slot processing chambers), a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 124 includes components of substrate processing systems. In some embodiments, substrate images are captured in situ (e.g., during performance of substrate processing operations via manufacturing equipment 124, metrology equipment 128 is located inside manufacturing equipment 124). In some embodiments, substrate images are captured after performance of substrate processing operations via manufacturing equipment 124.

In some embodiments, the sensors 126 provide sensor data (e.g., sensor values, such as historical sensor values and current sensor values) associated with manufacturing equipment 124. In some embodiments, the sensors 126 include one or more of an imaging device (e.g., camera, image capturing device, imaging sensor, etc.), a radio frequency (RF) sensor, a lift sensor, a pressure sensor, a temperature sensor, a flow rate sensor, a spectroscopy sensor, and/or the like. In some embodiments, the sensor data used for equipment health and/or product health (e.g., product quality). In some embodiments, the sensor data is received over a period of time. In some embodiments, sensors 126 provide sensor data such as values of one or more of image data (e.g., substrate images), leak rate, temperature, pressure, flow rate (e.g., gas flow), pumping efficiency, spacing (SP), High Frequency Radio Frequency (HFRF), electrical current, power, voltage, and/or the like.

In some embodiments, the metrology equipment 128 (e.g., imaging equipment, spectroscopy equipment, ellipsometry equipment, in-situ spectral reflectometry equipment, etc.) is used to determine metrology data (e.g., substrate images, inspection data, image data, spectroscopy data, ellipsometry data, material compositional, optical, or structural data, in-situ spectral reflectometry data, etc.) corresponding to substrates produced by the manufacturing equipment 124 (e.g., substrate processing equipment). In some examples, during and/or after the manufacturing equipment 124 processes substrates, the metrology equipment 128 is used to inspect portions (e.g., layers) of the substrates. In some embodiments, the metrology equipment 128 performs scanning acoustic microscopy (SAM), ultrasonic inspection, x-ray inspection, and/or computed tomography (CT) inspection. In some examples, after the manufacturing equipment 124 performs image classification and outlier detection of the substrate and the metrology equipment 128 is used to determine quality of the processed substrate (e.g., thicknesses of the layers, uniformity of the layers, interlayer spacing of the layer, and/or the like). In some embodiments, the metrology equipment 128 includes an image capturing device (e.g., SAM equipment, ultrasonic equipment, x-ray equipment, CT equipment, and/or the like).

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of substrate images, classes, clusters, algorithms, samples of substrate images, image encodings, historical data, current data, sensor data, metrology data, performance data, predictive data, etc.

In some embodiments, substrate images are captured of substrates (e.g., during substrate processing, after substrate processing, etc.).

In some embodiments, classes are groupings of substrates. In some embodiments, clusters are sub-classes of substrates within a class. In some embodiments a different action (e.g., algorithm used to perform metrology measurements) is used based on the class and/or cluster of the substrate image. If an incorrect action is performed, one or more of metrology data may be incorrectly determined, processing of the substrate may be incorrectly performed, incorrect manufacturing parameters may be used, etc. In some embodiments, sorting of substrate images into classes and/or clusters is automatically performed (e.g., via predictive component 114 and/or action component 122). In some embodiments, sorting of substrate images into classes and/or clusters is manually performed (e.g., by a user). A model may be trained using substrate images manually sorted into classes and/or clusters to generate a trained model to automatically sort substrate images into classes and/or clusters.

Algorithms may be associated with substrate processing. For example, an algorithm may be used to perform metrology (e.g., measurements) of a substrate image (e.g., to determine if the substrate image meets threshold values or does not meet threshold values). An algorithm may be associated with a class and/or cluster. Correctly sorting a substrate image into a class and/or cluster may be used to correctly choose the appropriate algorithm for performing metrology. Algorithms may be associated with other aspects of substrate processing (e.g., setting manufacturing parameters, performing a corrective action, etc.).

Sampling (e.g., samples) of substrate images may include up to a threshold amount of substrate images per class and/or cluster. This may cause a model to more correctly classify substrate images in classes and/or clusters to more accurately perform an action associated with substrate processing (e.g., selecting an algorithm for performing metrology.

In some embodiments, image encodings (e.g., image encodings) are from an intermediate layer of a trained model. The image encodings may be used to cluster images (e.g., via balanced iterative reducing and clustering using hierarchies (BIRCH)).

Historical data may include one or more of historical substrate images, historical classes, historical clusters, historical samplings, historical image encodings, etc. Historical data may be used to train a model.

Current data may include one or more of current substrate images, current classes, current clusters, current samplings, current image encodings, etc. Current data may be input into a trained model to determine predictive data.

Sensor data may be generated by sensors 126 (e.g., associated with manufacturing equipment 124, substrate images). Metrology data may be generated by metrology equipment 128 (e.g., measurements of substrates, substrate images). Metrology data may include one or more of property values of a substrate, thickness values of a substrate, etc. Manufacturing parameters (e.g., temperature, pressure, voltage, flow rate, etc.) may be used by manufacturing equipment 124 to process substrates.

Predictive data may be a predicted class and/or cluster for a substrate image. A misclassified substrate image may be a substrate image where the predicted class and/or cluster is incorrect (e.g., differs from a manually determined class and/or cluster). Predictive data may be used to perform an action (e.g., selecting an algorithm for performing metrology, performing image classification and outlier detection).

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 190. The data set generator 172 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically separated combinatoric subsets. In some embodiments, the data set generator 172 may explicitly partition the historical data into a training set (e.g., sixty percent of the historical data), a validating set (e.g., twenty percent of the historical data), and a testing set (e.g., twenty percent of the historical data). In some embodiments, the predictive system 110 (e.g., via predictive component 114) generates multiple sets of features (e.g., training features). In some examples a first set of features corresponds to a first set of types of substrate images that correspond to each of the data sets (e.g., training set, validation set, and testing set) and a second set of features correspond to a second set of types of substrate images that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of parameters of the training set (e.g., substrate images) and corresponding responses (e.g., classes and/or clusters). In some embodiments, multiple models are trained on the same parameters with distinct targets for the purpose of modeling multiple effects. In some examples, a first trained machine learning model was trained using historical data for all substrate images (e.g., substrate images 1-15), a second trained machine learning model was trained using a first subset of the historical data (e.g., substrate images 1-10), and a third trained machine learning model was trained using a second subset of the historical data (e.g., substrate images 5-15) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 (e.g., used for classification) refers to a model artifact that is created by the training engine 182 using a training set that includes data inputs and corresponding target outputs (e.g., correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides current substrate images (e.g., as input) to the trained machine learning model 190 and runs the trained machine learning model 190 (e.g., on the input to obtain one or more outputs). The predictive component 114 is capable of determining (e.g., extracting) predictive data from the trained machine learning model 190 and determines (e.g., extracts) uncertainty data that indicates a level of credibility that the predictive data corresponds to current data. In some embodiments, the predictive component 114 or action component 122 use the uncertainty data (e.g., uncertainty function or acquisition function derived from uncertainty function) to decide whether to use the predictive data to perform an action (e.g., classify a substrate image, select an algorithm for performing metrology on the substrate image, etc.) or whether to further train the model 190.

For purpose of illustration, rather than limitation, aspects of the disclosure describe the training of one or more machine learning models 190 using historical data and providing current data into the one or more trained probabilistic machine learning models 190 to determine predictive data. In other implementations, a heuristic model or rule-based model is used to determine predictive data (e.g., without using a trained machine learning model). In other implementations non-probabilistic machine learning models may be used. Predictive component 114 monitors historical data. In some embodiments, any of the information described with respect to data inputs are monitored or otherwise used in the heuristic or rule-based model.

In some embodiments, the functions of client device 120, predictive server 112, server machine 170, and server machine 180 are be provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines performance of additional image classification and outlier detection via etching based on the predictive data. In another example, client device 120 determines the predictive data based on data received from the trained machine learning model.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of determining predictive data to perform image classification and outlier detection in manufacturing facilities (e.g., substrate processing facilities), in some embodiments, the disclosure can also be generally applied to performing actions. Embodiments can be generally applied to performing actions based on data.

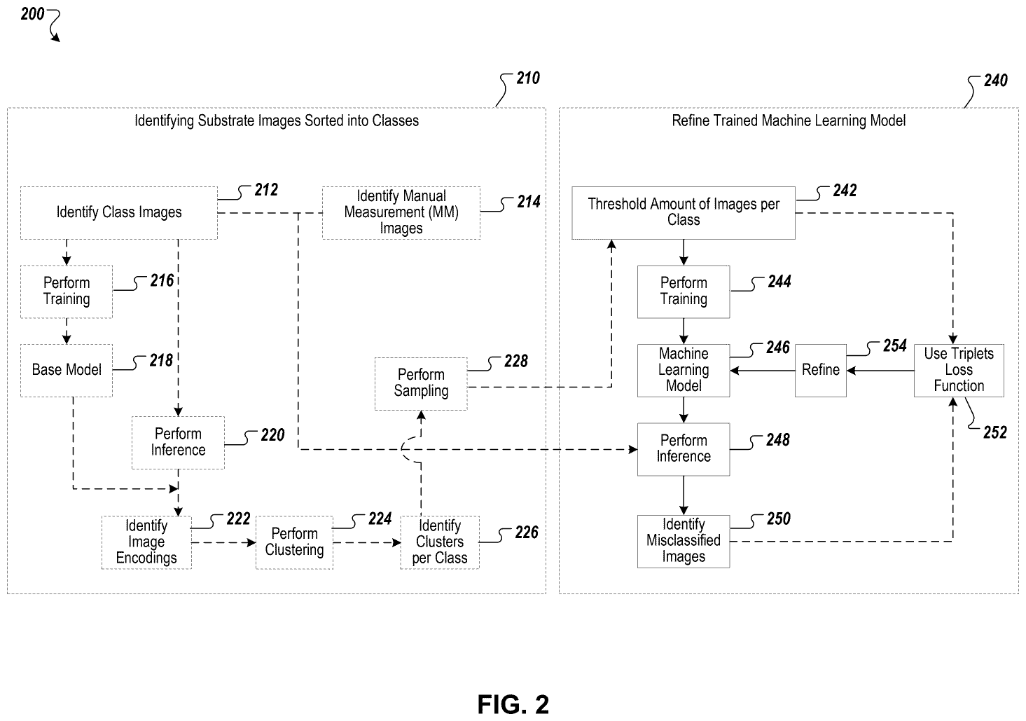

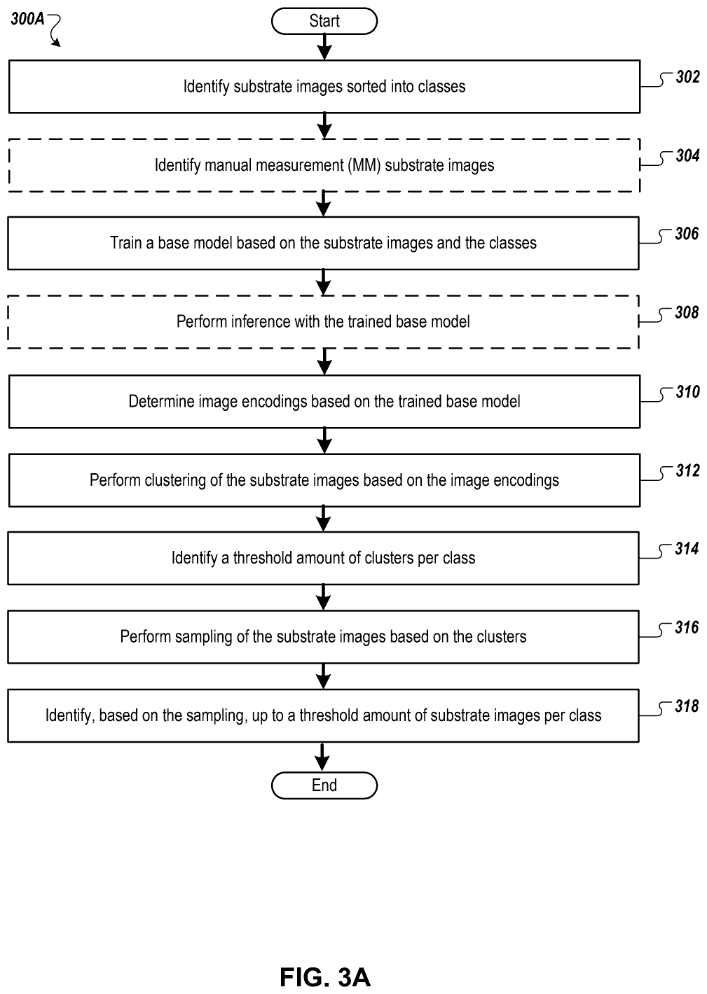

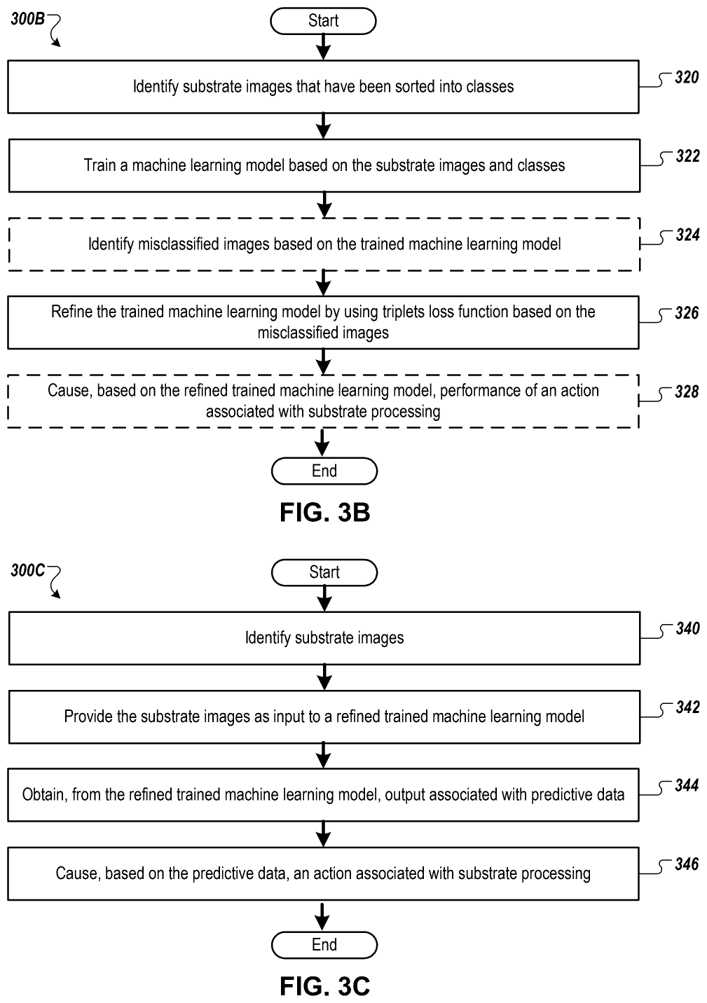

FIGS. 2 and 3A-C are flow diagrams of methods 200 and 300A-C associated with image classification and outlier detection, according to certain embodiments. In some embodiments, methods 200 and 300A-C are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some embodiments, methods 200 and 300A-C are performed, at least in part, by predictive system 110 and/or client device 120. In some embodiments, one or more operations of one or more of methods 200 and/or 300A-C are performed, at least in part, by predictive system 110. In some embodiments, a non-transitory storage medium stores instructions that when executed by a processing device (e.g., of predictive system 110, of server machine 180, of predictive server 112, of client device 120, etc.), cause the processing device to perform one or more of methods 200 and 300A-C.

For simplicity of explanation, methods 200 and 300A-C are depicted and described as a series of operations. However, operations in accordance with this disclosure can occur in various orders and/or concurrently and with other operations not presented and described herein. Furthermore, in some embodiments, not all illustrated operations are performed to implement methods 200 and 300A-C in accordance with the disclosed subject matter. In addition, those skilled in the art will understand and appreciate that methods 200 and 300A-C could alternatively be represented as a series of interrelated states via a state diagram or events.

FIG. 2 is a flow diagram of a method 200 associated with image classification and outlier detection, according to certain embodiments.

In some embodiments, the present disclosure performs neural network image classification and outlier detection using multi-layer losses neural network image classification and outlier detection using multi-layer losses (e.g., image classification and outlier detection using an approach that has similarities to model-agnostic meta-learning (MAML)). The present disclosure may be applied to different types of classifiers.

At block 210, processing logic identifies substrate images sorted into classes (e.g., and/or clusters). In some embodiments, block 210 includes one or more of blocks 212-228.

At block 212, processing logic identifies class images (e.g., images sorted into classes). At block 212, the substrate images may not be sorted into clusters. At block 212, there may be too many substrate images in certain classes and/or clusters that may cause a model to be incorrectly trained (e.g., skewed towards the classes and/or clusters where there are more substrate images).

At block 214, processing logic identifies manual measurement (MM) images (e.g., substrate images). MM images may be substrate images that do not belong to a class of block 212. Conventional models may fail to work for MM images and may provide higher false positive error rate than acceptable. The present disclosure may incorporate “other” class (e.g., MM images) detection capabilities into any classification network (e.g., machine learning model).

In some embodiments, the training dataset may include hundreds of substrate images (e.g., scanning electron microscope (SEM) images) that belong to about 25 classes (e.g., of block 212) and over one hundred substrate images (e.g., SEM images) representing the MM class (e.g., of block 214). The number of substrate images per class may vary from around ten to around 100.

At block 216, processing logic performs training of a base model (e.g., base network) using data input of substrate images from block 212 and target output of classes of block 212. The training of the base model may be by using only class images (e.g., substrate images sorted into classes, of block 212).

The training of the base model may be a warmup operation. The training of the base model may utilize all available class images (e.g., substrate images sorted into classes). Class balance (e.g., reducing numbers of images in classes and/or clusters to have a more equal representation) may not be performed in block 216. If a trained base model exists (e.g., at the time of adding a new class), this block 216 may be skipped.

To train the base model, one or more of the following operations may be performed:
Forward pass all substrate images of a class through the base model;
Record the activations at the penultimate layer;
Using activations and clustering (e.g., BIRCH clustering) to divide the images into clusters (e.g., about five clusters, see block 224); and

Sample up to about three substrate images from each cluster (e.g., clusters smaller than three images may be sampled 100%, see block 228).

In some embodiments, the present disclosure may include one or more of the following architecture features:
1) input: grayscale image (e.g., 244×244 grayscale image);
2) frozen layers: about five convolution blocks from pretrained model;
3) trainable convolutional layers: about three convolution layers to reduce the number of channels;
4) “flatten” layer that converts the output of convolution layers to a tensor (e.g., 1×4096 tensor);
5) dense layers: about three dense layers, the output of the last layer is substantially equal to the number of classes; and/or
6) log softmax activation.

At block 218, processing logic may evaluate the trained base model (e.g., performs training, validation, selection, and/or testing).

At block 220, processing logic performs interference of the trained base model. The processing logic may provide the substrate images of block 212 to the trained base model and obtain, from the trained base model, output associated with predictive data. The processing logic may determine classes of the substrate images based on the predictive data.

At block 222, processing logic identifies, based on the trained base model, image encodings. The image embeddings generated as a side-product can be used for further analysis on the substrate images or debugging the model.

At block 224, processing logic performs clustering (e.g., sorts into sub-classes) of the substrate images from block 212.

In some embodiments, there may be high intra-class variation. Each class may have multiple sub-classes (e.g., clusters, images within a sub-class may look similar to each other but visually different from other sub-classes). There may be an imbalance in the sub-classes as well (e.g., in a class of 55 substrate images, 40 substrate images may belong to one subclass and the remaining may constitute four sub-classes).

At block 226, processing logic identifies clusters per class of block 212. For example, the processing logic may identify about five clusters per class.

At block 228, processing logic performs sampling of the substrate images from block 212 to identify a threshold amount of substrate images per class (e.g., and per cluster). For example, the processing logic may select 2-3 images per cluster so that there are 10-15 substrate images per class.

The present disclosure may create smaller representative datasets of substrate images from larger datasets using clustering on image embeddings from intermediate layers. This may be done because of high intra-class variations.

The present disclosure may include creating smaller datasets (e.g., sampling of the overall dataset based on classes and/or clusters, about 10-15 substrate images per class). Classes larger than 15 images may be shrunk down (e.g., reduced). Overall random sampling may be problematic and may lead to sub-classes with low representation being missed.

At block 240, processing logic refines a trained machine learning model. In some embodiments, block 240 includes one or more of blocks 242-254.

At block 242, processing logic identifies the threshold amount of substrate images per class (e.g., receives from block 228).

The present disclosure may add a new class using about 10 images. In some embodiments, the present disclosure may be used with standard training sets and pretrained models. In some embodiments, the present disclosure uses few shot learning (e.g., learning based on a few images per cluster), convolutional neural nets, and/or multi-layer loss.

At block 244, processing logic performs training of a machine learning model using data input including the substrate images from block 242 and target output including the classes (e.g., and/or clusters) from block 242.

To perform the training of the model, the model weights may be updated about twice per training interval (e.g., epoch). The training may include one or more of the following operations:
Operation 1: compute NLL loss at the last layer and update weights;
Operation 2a: run prediction on all the substrate images in the trainset (e.g., sorted into classes) and all substrate images representative of “other” class (e.g., MM substrate images);
Operation 2b: identify failures—a class image (e.g., substrate image sorted into a class) is a failure if it not predicted into a correct class with a probability greater than a threshold value and an “other” class image (e.g., MM substrate image) is a failure if it is classified into one of the classes with probability greater than threshold value;
Operation 3: create smart triplets such that above misclassifications are minimized; and
Operation 4: compute triplet loss and update weights.

The present disclosure may have multiple forward passes per epoch and each forward pass has a different objective. The present disclosure may not accumulate the gradients before weight update and the same dataset may be used for different tasks.

The present disclosure may compute losses on different forward passes.

At block 246, processing logic may evaluate the trained machine learning model (e.g., performs training, validation, selection, and/or testing).

In some embodiments, the present disclosure creates models with few-shot-learning capability and robust “other” class detection (e.g., MM image class, recognizing images that do not belong to either class). The machine learning model may be trained using few-shot-learning. This means the model can learn to identify a new class when only a few (e.g., 10-15) substrate images are provided. When adding a new class, the model is to be retained using all classes since the dimensionality of layers may change.

The present disclosure may be used for cases where the intra-class variability is high and inter-class variability is low, and when training data is limited/expensive to generate.

The trained machine learning model of the present disclosure may use frozen convolution layers from a pretrained model and may add three trainable convolutional and three dense layers.

The model of the present disclosure may compute two losses: Negative Log Likelihood (NLL) loss at the output layer; and Triple Margin Loss at one of the hidden layers. The triplets (e.g., anchor item, similar item, and dissimilar item) may be chosen to mitigate the misclassifications (e.g., misclassified substrate images) that happened during that training interval (e.g. epoch).

The present disclosure may work well with just 10-15 images per class (e.g., 2-3 images per cluster in a class) which is much lower than data required for conventional solutions (e.g., conventional classifiers).

At block 248, processing logic performs interference of the trained machine learning model. The processing logic may provide the substrate images of block 212 and/or block 214 to the trained base model and obtain, from the trained base model, output associated with predictive data. The processing logic may determine classes of the substrate images based on the predictive data.

The model of the present disclosure may detect MM substrate images and have a low false positive error rate.

If an MM substrate image is predicted into a class with confidence greater than a threshold, then this is a false positive.

If a substrate image is predicted into a class (e.g., correct class) with confidence less than a threshold, this is a false negative.

If a substrate image is predicted into a wrong class with confidence greater than a threshold, this is a misclassification.

The present disclosure may reduce false positives, false negatives, and misclassifications compared to conventional solutions.

At block 250, processing logic identifies one or more substrate images that were misclassified by the trained machine learning model.

At block 252, processing logic uses triplet loss function on one or more of the misclassified substrate images from block 250.

The present disclosure may include triplet creation.

Triplets for misclassified images may include:
Anchor item—a misclassified image;
Similar (positive) item—image picked from the correct class (e.g., true class); and
Dissimilar (negative) item—image picked from the predicted class.

Triplets for false positives may include:
Anchor and positive example—image picked from predicted class; and
Negative example: the MM image.

A training iteration (e.g., one epoch) of the present disclosure may include:
1) a first task of forward passing class images (e.g., substrate images sorted into classes) and update weights of the model (e.g., block 244);
2) identifying failures by running inference on all images (e.g., class images and MM images), where a failure can be of three types:

Misclassification: class A image was classified as class B with confidence greater than a threshold value;
Prediction confidence for a class image was below a threshold value; and
The prediction confidence for an MM class image was greater than a threshold value;
3) create triplets (e.g., block 252); and
4) a second task of computing triplet loss (e.g., like in a Siamese network), where the loss is calculated on the penultimate layer and updating weights (e.g., block 254).

At block 254, processing logic refines the trained machine learning model of block 246 using the triplet loss function of block 252. The refined trained machine learning model may be used to perform an action associated with substrate processing.

The processing logic may train the machine learning model using the smaller dataset, where each training iteration (e.g., epoch) includes the following operations: 1) perform forward and backward pass (NLL loss function, see block 244); 2) identify fails cases (e.g., substrate images that were misclassified by the trained model, see block 250) and create smart triplets (e.g., anchor item, similar item, and dissimilar item); and 3) perform forward and backward pass (e.g., triplet loss function, see block 252). The processing logic may further calculate the triplet loss at the penultimate dense layer.

In some embodiments, the refined trained machine learning model may be integrated into auto image measurement software. The auto image measurement software may include multiple auto-measurement algorithms and the present disclosure may recommends the best algorithm for use for given substrate images. The present disclosure may heavily penalize false positive predictions.

In some embodiments, if a new algorithm has been created for a new pattern, the trained machine learning model can learn to recommend the correct algorithm with as few as 10 representative substrate images of the new pattern.

Auto image measurement software may use different algorithms for different types of patterned substrates. A substrate image (e.g., SEM image) may be identified (e.g., responsive to being uploaded by a user) to be measured by a processing device (e.g., via a web interface). Conventionally, a user selects the a measurement algorithm from a drop-down menu. The user may select the wrong measurement algorithm for the substrate image which leads to the measurements of the substrate image being erroneous (e.g., incorrectly indicating quality of the substrate, not being able to measure the substrate, etc.). The present disclosure may provide a recommendation system that takes a substrate image as input and suggests which algorithm (e.g., measurement algorithm to use). The recommendation system of the present disclosure may have one or more of the following capabilities:
Low false positive rate-better than the processing device (e.g., recommender) makes no recommendation than a wrong recommendation;
“Other” class detection—if a substrate image cannot be measured by any existing algorithm, the processing device may not make a recommendation; and/or
Few-short learning—it may be possible to add a new algorithm (e.g., measurement algorithm) to the recommendation list when there are only about 10-15 substrate images available that correspond to the new algorithm.

The model of the present disclosure may predict the class of a substrate image. There may be multiple algorithms recommended per class. The relation between class and recommended algorithms may be changed at any point in time. The images used for the model training set may be substrate images from semiconductor industry.

In some embodiments, the present disclosure can have direct application in other classification problems.

FIG. 3A is a flow diagram of a method 300A associated with identifying substrate images sorted into classes (e.g., for image classification and outlier detection), according to certain embodiments.

At block 302, processing logic identifies substrate images sorted into classes (e.g., see block 212 of FIG. 2). In some embodiments, the substrate images were manually sorted into the classes. The classes may be associated patterns in the substrate images. Each class may be associated with a corresponding algorithm (e.g., measurement algorithm) to be used to perform metrology (e.g., measurements) of that type of substrate image.

At block 304, processing logic identifies MM substrate images (e.g., see block 214 of FIG. 2). MM substrate images may be substrate images that do not match any of the classes.

At block 306, processing logic trains a base model based on the substrate images (e.g., from block 302) and the classes (e.g., to generate a trained machine learning, see block 216 of FIG. 2).

In some embodiments, method 300A includes forwarding passing substrate images through the base model, recording one or more activations at a penultimate layer of the base model, using the one or more activations and clustering to divide the substrate images into a set of clusters, and sampling up to a threshold amount of images from each cluster of the set of clusters to generate the substrate images that have been sorted into the classes.

In some embodiments, method 300A includes training the base model based on historical substrate images sorted into historical classes (e.g., to generate a trained base model) and sorting, based on image encodings of the trained base model, the historical substrate images into clusters. The substrate images used in FIG. 3B may include clustered substrate images from each of the clusters.

In some embodiments, at block 308, processing logic performs inference with the trained base model (e.g., see block 220 of FIG. 2). The processing logic may train, validate, select, and/or test base models. The processing logic may provide substrate images as input to the trained base model.

At block 310, processing logic determines image encodings based on the trained base model (e.g., see block 222 of FIG. 2).

At block 312, processing logic performs clustering of the substrate images based on the image encodings (e.g., see block 224 of FIG. 2).

At block 314, processing logic identifies a threshold amount of clusters per class (e.g., see block 226 of FIG. 2).

At block 316, processing logic performs sampling of the substrate images based on the clusters (e.g., see block 228 of FIG. 2).

At block 318, processing logic identifies, based on the sampling, up to a threshold amount of substrate images per class.

FIG. 3B is a flow diagram of a method 300B associated with refining a trained machine learning model (e.g., for image classification and outlier detection), according to certain embodiments.

At block 320 processing logic identifies substrate images that have been sorted into classes (e.g., see block 242 of FIG. 2, see block 318 of FIG. 3A).

At block 322 processing logic trains a machine learning model based on the substrate images and classes (e.g., to generate a trained machine learning model, see block 244 of FIG. 2). At block 322, the processing logic may train the machine learning model using data input including the substrate images and target output including the classes to generate the trained machine learning model. In some embodiments, the training of the machine learning model includes using a negative log-likelihood loss function. In some embodiments, the training of the machine learning model includes using few-shot learning by using up to a threshold amount of substrate images in each class and/or cluster (e.g., sub-class).

At block 324 processing logic identifies misclassified images based on the trained machine learning model (e.g., see block 250 of FIG. 2). The processing logic may identify the misclassified images responsive to inputting substrate images sorted into classes (e.g., see block 212 of FIG. 2, block 302 of FIG. 3A) and MM images (e.g., see block 214 of FIG. 2, block 304 of FIG. 3A).

At block 326 processing logic refines the trained machine learning model by using triplet loss function based on one or more substrate images misclassified by the trained machine learning model (e.g., see blocks 252-254 of FIG. 2) to provide a refined trained machine learning model (e.g., associated with performance of an action associated with substrate processing). In some embodiments, block 326 includes refining the trained machine learning model using a triplet loss function based on one or more substrate images misclassified by the trained machine learning model and providing (e.g., generating) a refined trained machine learning model associated with a performance of an action associated with substrate processing.

A misclassified image of the one or more substrate images may be of a first class and is misclassified in a second class. The using of the triplet loss function may include using the misclassified image as an anchor item, using a first correctly classified substrate image from the first class as a similar item, and using a second correctly classified substrate image from the second class as a dissimilar item.

At block 328 processing logic causes, based on the refined trained machine learning model, performance of an action (e.g., a corrective action) associated with substrate processing (e.g., see block 346 of FIG. 3C). The performance of the action may include providing current substrate images to the refined trained machine learning model to select an algorithm (e.g., measurement algorithm) for generation of metrology data.

FIG. 3C is a flow diagram of a method 300C associated with using a refined machine learning model (e.g., for performing an action associated with substrate processing, for image classification and outlier detection), according to certain embodiments.

At block 340 processing logic identifies substrate images (e.g., associated with substrate processing). The substrate images may be captured during or after one or more substrate processing operations.

At block 342 processing logic provides the substrate images as input to a refined trained machine learning model (e.g., refined via block 254 of FIG. 2, refined via block 326 of FIG. 3B). The refined trained machine learning model may have been trained based on historical substrate images that have been sorted into historical classes (e.g., to generate a trained machine learning model) and refined using a triplet loss function based on one or more substrate images misclassified by the trained machine learning model.

In some embodiments a misclassified image of the one or more substrate images is of a first class and is misclassified in a second class. The using of the triplet loss function may include using the misclassified image as an anchor item, using a first correctly classified substrate image from the first class as a similar item, and using a second correctly classified substrate image from the second class as a dissimilar item.

In some embodiments, a base model is trained based on historical substrate images sorted into historical classes, the historical substrate images being sorted into clusters based on image encodings of the trained base model, the substrate images used to train the machine learning model including clustered substrate images from each of the clusters.

In some embodiments, the trained machine learning model is trained using a negative log-likelihood loss function. In some embodiments, the trained machine learning model is trained using few-shot learning by using up to a threshold amount of substrate images in each class of the classes.

In some embodiments, the substrate images sorted into the classes is by forwarding passing substrate images through a base model, recording one or more activations at a penultimate layer of the base model, using the one or more activations and clustering to divide the substrate images into a set of clusters, and sampling up to a threshold amount of images from each cluster of the set of clusters to generate the substrate images that have been sorted into the classes.

At block 344 processing logic obtains, from the refined trained machine learning model, output associated with predictive data.

At block 346 processing logic causes, based on the predictive data, an action associated with substrate processing (e.g., see block 328 of FIG. 3B). In some embodiments, the performance of the action may include selecting an algorithm (e.g., measurement algorithm) for generation of metrology data (e.g., responsive to the substrate image being sorted into a class with a confidence level meeting a threshold value). In some embodiments, the performance of the action includes performing a corrective action. In some embodiments, the performance of the corrective action can include providing an alert that the substrate image was not sorted into a class with a confidence level meeting a threshold value. In some embodiments, the performance of the corrective action can include providing an alert that the substrate image and/or substrate is to be manually measured. In some embodiments, the performance of the corrective action can include providing an alert that the substrate is to be discarded. The performance of the corrective action can include updating of manufacturing parameters.

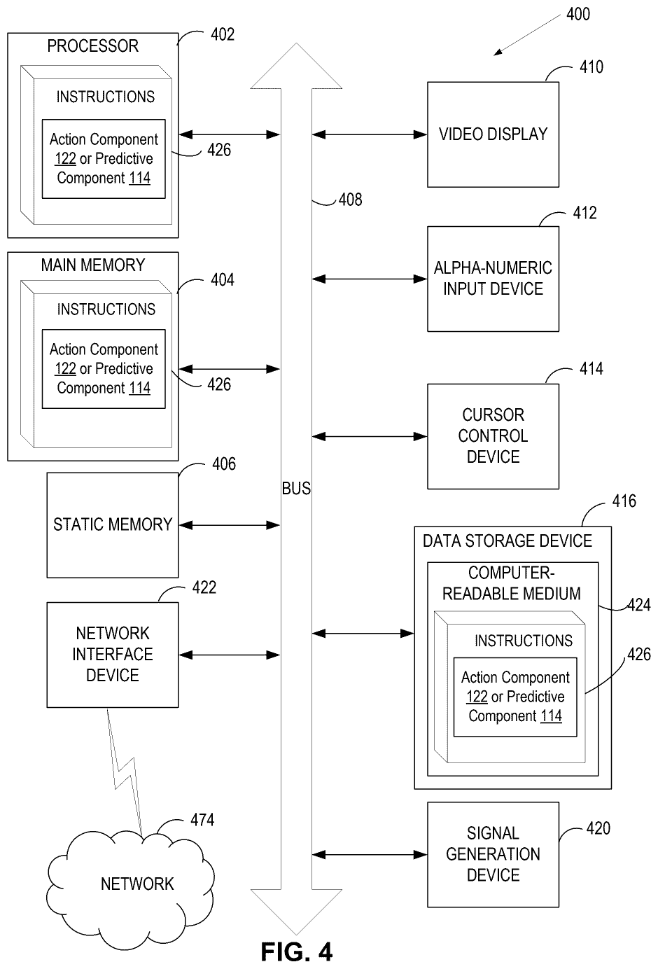

FIG. 4 is a block diagram illustrating a computer system 400, according to certain embodiments. In some embodiments, the computer system 400 is one or more of client device 120, predictive system 110, server machine 170, server machine 180, or predictive server 112.

In some embodiments, computer system 400 is connected (e.g., via a network, such as a Local Area Network (LAN), an intranet, an extranet, or the Internet) to other computer systems. In some embodiments, computer system 400 operates in the capacity of a server or a client computer in a client-server environment, or as a peer computer in a peer-to-peer or distributed network environment. In some embodiments, computer system 400 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 includes a processing device 402, a volatile memory 404 (e.g., Random Access Memory (RAM)), a non-volatile memory 406 (e.g., Read-Only Memory (ROM) or Electrically Erasable Programmable ROM (EEPROM)), and a data storage device 416, which communicate with each other via a bus 408.

In some embodiments, processing device 402 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 400 further includes a network interface device 422 (e.g., coupled to network 474). In some embodiments, computer system 400 also includes a video display unit 410 (e.g., a liquid crystal display (LCD)), an alphanumeric input device 412 (e.g., a keyboard), a cursor control device 414 (e.g., a mouse), and a signal generation device 420.

In some implementations, data storage device 416 includes a non-transitory computer-readable storage medium 424 on which store instructions 426 encoding any one or more of the methods or functions described herein, including instructions encoding components of FIG. 1 (e.g., action component 122, predictive component 114, etc.) and for implementing methods described herein.

In some embodiments, instructions 426 also reside, completely or partially, within volatile memory 404 and/or within processing device 402 during execution thereof by computer system 400, hence, in some embodiments, volatile memory 404 and processing device 402 also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as application-specific integrated circuits (ASICs), field programmable gate arrays (FPGAs), digital signal processors (DSPs), or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “training,” “refining,” “causing,” “using,” “classifying,” “training,” “sorting,” “forwarding,” “recording,” “sampling,” “providing,” “obtaining,” “generating,” “determining,” “outputting,” “predicting,” “updating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein or includes a general-purpose computer system selectively programmed by a computer program stored in the computer system. Such a computer program is stored in a computer-readable tangible storage medium.

The methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
identifying a plurality of substrate images that have been sorted into a plurality of classes;
training a machine learning model using data input comprising the plurality of substrate images and target output comprising the plurality of classes; and
refining the trained machine learning model using a triplet loss function based on one or more substrate images misclassified by the trained machine learning model to provide a refined trained machine learning model associated with performance of an action associated with substrate processing.

2. The method of claim 1, wherein:
a misclassified image of the one or more substrate images is of a first class and is misclassified in a second class; and
the using of the triplet loss function comprises using the misclassified image as an anchor item, using a first correctly classified substrate image from the first class as a similar item, and using a second correctly classified substrate image from the second class as a dissimilar item.

3. The method of claim 1, wherein the performance of the action comprises providing current substrate images to the refined trained machine learning model to select an algorithm for generation of metrology data.

4. The method of claim 1 further comprising:
training a base model based on a plurality of historical substrate images sorted into a plurality of historical classes; and
sorting, based on image encodings of the trained base model, the historical substrate images into a plurality of clusters, wherein the plurality of substrate images comprise clustered substrate images from each of the plurality of clusters.

5. The method of claim 1, wherein the training of the machine learning model comprises using a negative log-likelihood loss function.

6. The method of claim 1, wherein the training of the machine learning model comprises using few-shot learning by using up to a threshold amount of substrate images in each class of the plurality of classes.

7. The method of claim 1 further comprising:
forwarding passing substrate images through a base model;
recording one or more activations at a penultimate layer of the base model;
using the one or more activations and clustering to divide the substrate images into a set of clusters; and
sampling up to a threshold amount of images from each cluster of the set of clusters to generate the plurality of substrate images that have been sorted into the plurality of classes.

8. A method comprising:
identifying current substrate images associated with substrate processing;
providing the current substrate images as input to a refined trained machine learning model, the refined trained machine learning model having been trained based on a plurality of substrate images that have been sorted into a plurality of classes and having been refined using a triplet loss function based on one or more substrate images misclassified by the trained machine learning model;
obtaining, from the refined trained machine learning model, output associated with predictive data; and
causing, based on the predictive data, performance of an action associated with the substrate processing.

9. The method of claim 8, wherein:
a misclassified image of the one or more substrate images is of a first class and is misclassified in a second class; and
the using of the triplet loss function comprises using the misclassified image as an anchor item, using a first correctly classified substrate image from the first class as a similar item, and using a second correctly classified substrate image from the second class as a dissimilar item.

10. The method of claim 8, wherein the performance of the action comprises selecting an algorithm for generation of metrology data.

11. The method of claim 8, wherein a base model is being trained based on a plurality of historical substrate images sorted into a plurality of historical classes, the historical substrate images being sorted into a plurality of clusters based on image encodings of the trained base model, the plurality of substrate images comprising clustered substrate images from each of the plurality of clusters.

12. The method of claim 8, wherein the trained machine learning model is being trained using a negative log-likelihood loss function.

13. The method of claim 8, wherein the trained machine learning model is being trained using few-shot learning by using up to a threshold amount of substrate images in each class of the plurality of classes.

14. The method of claim 8, the plurality of substrate images sorted into the plurality of classes is by forwarding passing substrate images through a base model, recording one or more activations at a penultimate layer of the base model, using the one or more activations and clustering to divide the substrate images into a set of clusters, and sampling up to a threshold amount of images from each cluster of the set of clusters to generate the plurality of substrate images that have been sorted into the plurality of classes.

15. A non-transitory machine-readable storage medium storing instructions which, when executed cause a processing device to perform operations comprising:
identifying a plurality of substrate images that have been sorted into a plurality of classes;
training a machine learning model using data input comprising the plurality of substrate images and target output comprising the plurality of classes; and
refining the trained machine learning model using a triplet loss function based on one or more substrate images misclassified by the trained machine learning model to provide a refined trained machine learning model associated with performance of an action associated with substrate processing.

16. The non-transitory machine-readable storage medium of claim 15, wherein:
a misclassified image of the one or more substrate images is of a first class and is misclassified in a second class; and
the using of the triplet loss function comprises using the misclassified image as an anchor item, using a first correctly classified substrate image from the first class as a similar item, and using a second correctly classified substrate image from the second class as a dissimilar item.

17. The non-transitory machine-readable storage medium of claim 15, wherein the performance of the action comprises providing current substrate images to the refined trained machine learning model to select an algorithm for generation of metrology data.

18. The non-transitory machine-readable storage medium of claim 15, the operations further comprising:
training a base model based on a plurality of historical substrate images sorted into a plurality of historical classes; and
sorting, based on image encodings of the trained base model, the historical substrate images into a plurality of clusters, wherein the plurality of substrate images comprise clustered substrate images from each of the plurality of clusters.

19. The non-transitory machine-readable storage medium of claim 15, wherein the training of the machine learning model comprises using a negative log-likelihood loss function.

20. The non-transitory machine-readable storage medium of claim 15, wherein the training of the machine learning model comprises using few-shot learning by using up to a threshold amount of substrate images in each class of the plurality of classes.
